(19) United States
(12) Patent Application Publication
(10) Pub. No.: US 2006/0184446 A1
(43) Pub. Date: Aug. 17, 2006

(54) Method for indicating the market value of an employee stock option

(76) Inventor: Whitney Ross, Tampa, FL (US)

Correspondence Address: KATTEN MUCHIN ROSENMAN LLP, 525 WEST MONROE STREET, CHICAGO, IL, 60661-3693, US

(21) Appl. No.: 11/352,348

(22) Filed: Feb. 13, 2006

Related U.S. Application Data
(60) Provisional application No. 60/653,189, filed on Feb. 15, 2005.
(60) Provisional application No. 60/703,905, filed on Jul. 29, 2005.

(51) Int. Cl. G06Q 40/00

(52) U.S. Cl. 705/37

(57) ABSTRACT

A method is disclosed for indicating the value of an employee stock option issued by an employer to an employee. The method comprises the steps of issuing the employee stock option having employee stock option restrictions. A secondary stock option of the stock of the employer is established having secondary stock option restrictions. The secondary stock option is sold to an independent buyer. The value of the employee stock option is derived from a valuation paid by the independent buyer for the secondary stock option.

### CROSS-REFERENCE TO RELATED APPLICATIONS

This patent application claims priority to U.S. Provisional Patent Application Ser. No. 60/653,189, filed Feb. 15, 2005, and to U.S. Provisional Patent Application Ser. No. 60/703,905, filed Jul. 29, 2005, the entireties of which are incorporated herein by reference.

### FIELD OF THE INVENTION

This invention relates to stocks and options and more particularly to a novel method for indicating the market value of an employee stock option.

### BACKGROUND OF THE INVENTION

In the last half of the 20th century, publicly owned corporations devised various means for compensating employees for their services other than by direct taxable cash payments. Various types of deferred compensation plans, involving the direct or indirect use of the corporation's authorized but unissued shares of capital stock, were constructed. One of the more popular forms of deferred compensation plans emerging from this period, in large part because of associated federal income tax benefits granted by the United States Internal Revenue Code, has been the employee “qualified” or, more recently, “incentive” stock option plan.

Under such a plan, the employer corporation grants to an employee an option to acquire all or any portion of a certain number of shares of the employer's capital stock, but only following the passage of one or more future “vesting” dates. Thereafter the employee is allowed to exercise his or her option rights and pay a predetermined price (commonly referred to as the “strike price”), generally equal to the fair market value on the date of the option's grant of each share later being acquired.

To achieve the sought after income tax benefits, employee stock options are subjected to various conditions, limitations and restrictions including non-transferability by the holder, non-exercisability prior to the occurrence of the stated vesting date, subsequent exercisability only during the option holder's employment (or a brief period following employment termination without cause) and a limited vesting period.

Historically, employers have been required to recognize the value of stock options as a compensation expense for financial accounting purposes only when exercised rather than when granted. In December 2004, the Financial Accounting Standards Board (the “FASB”) issued its Statement of Financial Accounting Standard #123 (revised) relating to “share based payments”. This Statement requires a public entity to measure the cost of employee services received in exchange for an award of equity instruments, which includes stock options, based on the grant-date fair value of the award, and to recognize such cost over the period during which an employee is required to provide service in exchange for the award. Public entities will adopt this Statement using a modified version of prospective application. Under this application, the Statement will apply to new awards and to awards modified, repurchased or cancelled after the required effective date and to awards not yet vested that exist as of the effective date.

Since the publication of the first edition of the Statement in 1995, more than 1,000 companies have opted to voluntarily expense their employee stock option grants as a compensation expense, but most larger companies and those whose compensation arrangements rely heavily upon deferred plans involving stock option grants have continued to defer reporting the related expense because of the negative and accelerated impact that it will have on their periodic earnings. With the publication of the revised Statement, its approval by the Association of Independent Certified Public Accountants and the United States Securities and Exchange Commission, and its application being initially required for larger entities as of the beginning of the first interim or annual reporting period occurring after Jun. 15, 2005, widespread mandatory expensing of the fair market value of stock option grants will shortly begin.

To properly report its earnings, an employer will now be required to determine its actual expense arising from the grant of each employee stock option. The most accurate indication of such expense will be the option's fair market valve on the grant date. Fair value is defined in the FASB's Concepts Statement No. 7 as the amount at which an asset could be bought or sold in a current transaction, not involving a forced or liquidation sale, between a willing seller and willing buyer. Since, however, the incentive stock option is non-transferable by the employee holder, its fair value cannot be readily determined on the grant date in the manner contemplated by the referenced Concepts Statement.

The prior art has used various mathematical models in an effort to determine theoretically the value of an employee stock option. Mathematical models such as Black-Scholes, the binomial model, the lattice model and other option pricing models attempt to determine the value of an employee stock option without considering any market driven factors. These mathematical models provide imprecise and generally inflated values which, if adopted by the option granting employer, will result in its periodic reporting of inaccurately reduced earnings.

It is an object of the present invention to provide a method for indicating the market value of an employee stock option that more accurately reflects the value of an employee stock option than the estimated methods of the prior art.

Another object of the present invention is to provide a method for indicating the market value of an employee stock option that provides a value of an employee stock option based on a market value in contrast to an estimated or predicted value of an employee stock option of the prior art.

Another object of the present invention is to provide a method for indicating the market value of an employee stock option that provides a value of an employee stock option based on a market value in contrast to the value generated by application of the Black-Scholes formulaic approach.

Another object of the present invention is to provide a method for indicating the market value of an employee stock option that more accurately reflects the value of an employee stock option.

Another object of the present invention is to provide a method for indicating the market value of an employee stock option that more accurately reflects the expense incurred by the employer issuing the employee stock option.

Another object of the present invention is to provide a method for indicating the value of an employee stock option for more accurately determining the expense of the employee stock option for enabling the employer to more accurately report the earnings of the employer.

Another object of the present invention is to provide an article comprising a secondary security for sale to an independent buyer for indicating a value of said employee stock option.

The foregoing has outlined some of the more pertinent objects of the present invention. These objects should be construed as being merely illustrative of some of the more prominent features and applications of the invention. Many other beneficial results can be obtained by modifying the invention within the scope of the invention. Accordingly other objects in a full understanding of the invention may be had by referring to the summary of the invention and the detailed description describing the preferred embodiment of the invention.

### SUMMARY OF THE INVENTION

A specific embodiment of the present invention is shown in the attached drawings. For the purpose of summarizing the invention, the invention relates to a method for indicating the value of an employee stock option issued by an employer to an employee comprising the steps of issuing the employee stock option having employee stock option restrictions. A secondary stock option is established of the stock of the employer having secondary stock option restrictions. The secondary stock option is sold to an independent buyer. The value of the employee stock option is derived from a valuation paid by the independent buyer for the secondary stock option.

In another embodiment, the invention is to a method for indicating the market value of an employee stock option issued by an employer to a plurality of employees, comprising the steps of: issuing an employee stock option to the plurality of employees having employee stock option restrictions imposed upon the plurality of employees in the exercise of the stock option; establishing secondary stock options on the stock of the employer having secondary stock option restrictions being substantially the same as the employee stock option restrictions imposed upon the plurality of employees; selling the secondary stock options to a multiplicity of independent buyers at market value; and deriving the value of the employee stock options by using a valuation paid by the multiplicity of independent buyers of the secondary stock option.

In another embodiment, the invention is to a method for indicating the value of an employee stock option issued by an employer to an employee, comprising the steps of: issuing the employee stock option having employee stock option; calculating a theoretical value of the employee stock option through the use of a mathematical model; obtaining a previous derived value from a previously issued secondary stock offering for a previously issued employee stock option; calculating a previous theoretical value for the previously issued employee stock option through the use of the mathematical model; calculating a correction factor from the previous derived value and the previous theoretical value for the previously issued employee stock option; and applying the correction factor to the theoretical value of the employee stock option to provide a calculated theoretical derived value to determine the expense of the employee stock option to the employer.

In yet another embodiment, the invention is to an article, comprising a secondary security for sale to an independent buyer related to an employee stock option with a valuation paid by said independent buyer of said secondary security indicating a value of said employee stock option.

Optionally, the employee stock option has a vesting period between a grant date of the employee stock option and a vesting date of the employee stock option during which the employee may not exercise the employee stock option. The employee stock option optionally has an exercise period between the vesting date and an expiration date during which the employee may exercise the employee stock option. An employee optionally may forfeit the employee stock option upon termination of employment of the employee prior to the vesting of the employee stock option. The employee stock option also may be non-transferable by the employee.

The employee stock option has restrictions optionally including a strike price, a number of the shares underlying the option, a stock option vesting date; a stock option expiration date, and a stock option forfeiture term upon termination of employment prior to fulfillment of vesting requirement.

The secondary stock option may be offered to a plurality of independent buyers. Preferably, the secondary stock option has secondary stock option restrictions similar to the employee stock option restrictions. The secondary stock option optionally has a vesting period between a grant date of the employee stock option and a vesting date of the employee stock option during which the independent buyer may not exercise the secondary stock option. The secondary stock option optionally is non-transferable by the independent buyer. The secondary stock option optionally has a forfeiture rate related to the employee stock options forfeited within the employee stock option grant.

The secondary stock option has secondary stock option restrictions optionally including a strike price, a number of the shares underlying the option, a stock option vesting date; a stock option expiration date, and a forfeiture rate similar to the employee stock options forfeited within the employee stock option grant.

The secondary stock option may be sold to the independent buyer or a multiplicity of independent buyers at a market value in an open market. In the alternative, the secondary stock option may be sold to the independent buyer at a negotiated value, a competitively generated value, an auction clearing value or similar methods of selling the secondary stock option.

The valuation or price paid by the independent buyer is used to derive the value of the employee stock option. The value of the employee stock option may be the actual market valuation paid by the independent buyer or may be derived from the actual market valuation paid by the independent buyer.

The invention is also incorporated into an article comprising a secondary stock option security for sale to an independent buyer. The secondary stock option security preferably has substantially the same restrictions as a related employee stock option. A valuation or price paid by the independent buyer of the secondary security indicates a value of the employer stock option.

The foregoing has outlined rather broadly the more pertinent and important features of the present invention in order that the detailed description that follows may be better understood so that the present contribution to the art can be more fully appreciated. Additional features of the invention will be described hereinafter which form the subject matter of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention.

### BRIEF DESCRIPTION OF THE DRAWINGS

For a fuller understanding of the nature and objects of the invention, reference should be made to the following detailed description taken in connection with the accompanying drawings in which:

FIG. 1 is a block diagram of a first embodiment of a method for indicating the value of an employee stock option issued by an employer to an employee;

FIG. 2 is a diagram further illustrating the employee stock option restrictions of FIG. 1;

FIG. 3 is a diagram further illustrating the secondary stock option restrictions of FIG. 1;

FIG. 4 is a diagram further illustrating the selling of the secondary stock option restrictions of FIG. 1;

FIG. 5 is a diagram further illustrating the derived value of FIG. 1.

FIG. 6 is a diagram illustrating relationships of the derived value 80 of FIG. 1 with theoretical mathematical models of the prior art;

FIG. 7 is an equation for determining market value correction factor from a comparison of a derived value and a theoretical value from a prior stock option transaction;

FIG. 8 is a block diagram of a second embodiment of a method for indicating the value of an employee stock option issued by an employer to an employee; and

FIG. 9 is a chart comparing a theoretical derived value of an employee stock option as a percentage of Black-Scholes.

Similar reference characters refer to similar parts throughout the several Figures of the drawings.

### DETAILED DESCRIPTION OF THE INVENTION

Employee stock options have not historically been accurately valued because they are typically not sold to employees. Rather, employee stock options are typically given or granted by an employer to an employee. Instead, companies have relied on the flawed Black-Scholes formula. The valuation produced by Black-Scholes or other models is hypothetical, rigid and ignores most of the value inhibiting characteristics inherent to employee stock options, which is why the Black-Scholes formula is universally derided as an inadequate valuation technique.

The method of the present invention is substantially different from existing techniques and relies on fundamentally different principles than Black-Scholes. The method is capable of capturing the value inhibiting characteristics inherent to employee stock options. Based on direction by the Financial Accounting Standards Boards (“FASB”), the method is expected to be acceptable to auditors and the SEC. Due to its ability to accurately measure the value of employee stock options, the method is capable of materially reducing compensation expense to the employer. As a result, the method is likely to restore the efficient use of employee stock options as viable compensation, motivation and retention tools.

The method of the present invention is perceived to be superior to existing valuation techniques because it provides a fair market value for employee stock options. The method is visible, verifiable and transparent. The valuation method is not subjective or easily manipulated. Finally, it may be consistently applied to all subscribers.

As an overview, in one aspect, the invention is to a method for indicating the value of an employee stock option issued by an employer to an employee, comprising the steps of: (a) issuing the employee stock option having employee stock option restrictions; (b) establishing a secondary stock option of the stock of the employer having secondary stock option restrictions; (c) selling the secondary stock option to an independent buyer; and (d) deriving the value of the employee stock option from a valuation (e.g., price) paid by the independent buyer for the secondary stock option.

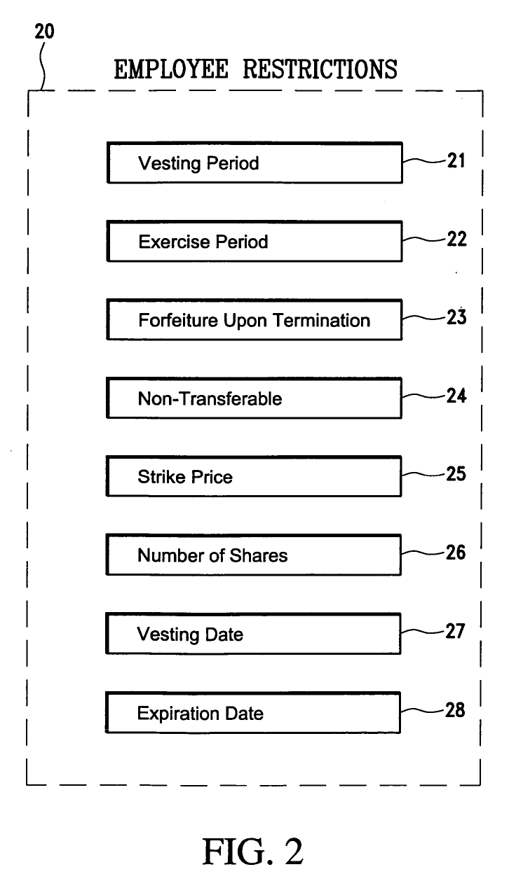

In this aspect of the invention, the employer establishes an employee stock option plan. The employer will then establish a grant or issue date upon which it expects to distribute or issue a number of stock options to its employees. The employer will establish the characteristics, terms, conditions and restrictions of the proposed grant as set forth in FIG. 2, discussed in more detail below. The employee stock option restrictions may be selected from the group consisting of: a vesting period, an exercise period, a forfeiture upon termination condition, a non-transferable condition, a strike price, a number of shares allocated to the employee stock option, a vesting date, and an expiration date. While not essential, the employer may, in addition to the valuation technique of the present invention, value the option grant using the historically relied upon Black-Scholes method.

Benefits to performing the Black-Scholes valuation may be numerous. These benefits may include: having a better understanding of the employee grant, having a yard stick by which to evaluate alternate valuation metrics, potentially tying execution fees to the variance from the Black-Scholes valuation, and others.

Additionally, the employer establishes a secondary stock option of the stock of the employer having secondary stock option restrictions. Preferably, the employer authorizes the execution of a secondary stock option on the grant date of the employee stock option. Ideally, the secondary stock option is a newly created security that is custom designed to emulate the valuation characteristics of the employee stock options being granted to employees. Preferably, the characteristics are as closely similar as is practicable.

The secondary stock option could be any number of different structures. These secondary stock options should have similar or identical rights, conditions and restrictions as those employee stock options being granted internally on the same or similar grant date. Thus, like the employee stock option, the secondary stock option restrictions may be selected from the group consisting of: a vesting period, an exercise period, a forfeiture upon termination condition, a non-transferable condition, a strike price, a number of shares allocated to the employee stock option, a vesting date, and an expiration date.

For example, the secondary stock option preferably remains unvested for a time corresponding to the vesting conditions of the employee stock options. If the employee stock options do not vest for three years, then the secondary stock option should also have a vesting condition specifying that vesting occurs in three years. The buyer of the secondary stock option would have no recourse with respect to the secondary stock option until three years have elapsed.

The secondary stock option preferably is also non-transferable. The secondary stock option preferably cannot be sold by the original buyer. Similar to employees stock options, the secondary stock options should only be held or executed by the third party buyer.

Preferably, the secondary stock option is also forfeitable. The forfeiture issue requires a slightly different set of conditions than those of the employee stock option, but this difference is designed specifically to capture the value characteristic of the entire employee stock option. In a preferred embodiment, the buyer of the secondary stock option should forfeit those secondary stock options in the same or similar proportion as those employee stock options that are forfeited internally at the employer over the specified vesting period. For example, should 10% of employee stock options granted to employees in a particular offering be forfeited over the vesting period, the buyer purchasing the secondary stock option would forfeit 10% of the secondary stock option.

Typically, an employee receives either 0% or 100% of the benefits of his or her specific employee stock options grant depending on whether the vesting requirement has been satisfied. Should an employee depart the employer during the vesting period (which may be, for example, 1, 2, 3, 4, 5 or more years), the employee would receive 0% of the specific employee stock options grant. If the employee was employed after the expiration of the vesting period, the employee would own 100% of the grant. Duplicating this all or nothing characteristic for the parallel securities (secondary stock options) would not adequately capture the value proposition of the whole offering.

In one aspect, the employer accounts for the expected value of the entire employee stock option. If the employer estimates that 10% of the employee stock options will be forfeited over the vesting period, that employer would only allocate 90% of the grant value of the employee stock option as expense. Structuring the newly created security to tie forfeitability to the forfeiture rate of the entire grant adequately captures the valuation characteristic of the entire employee option.

In many cases, the secondary stock option would be a private placement. While a 506 exemption private placement is perceived to be the preferred structure, the choice would depend on the circumstances specific to the subscriber or the entity issuing the secondary stock option. The secondary stock option preferably is small in size in terms of number of options relative to the employee stock option. Although most subscribers would likely keep transaction size small, the relative size of the transaction is unimportant for the purpose of the valuation.

In addition, the method comprises a step of selling the secondary stock options to one or more third party buyer(s). The selling step could be conducted in a variety of ways. It is preferred that the method would be conducted as a competitive auction. It has been established through auction theory, game theory and capital market experience that transactions can be structured and executed in such a way as to capture a market value.

In one embodiment, the employee retains a disinterested third party seller who undertakes the step of selling the secondary stock options to the one or more third party buyer(s). This aspect may be highly desirable in order to minimize the appearance of inappropriate employer influence in the sale of the secondary stock options.

The sale of the secondary stock options preferably is concurrently executed, separate and only a proposed transaction that is distinct from the internally granted employee stock option offering. Alternatively, the sale of the secondary stock option may occur before or after the establishment and/or issuance or the employee stock options.

As indicated above, the structure of the secondary stock option preferably is determined based on the characteristics (e.g., restrictions) of the employee stock option. The method optionally is reviewed and/or approved by one or more experts, e.g., accountants, auditors or the like. The expert, e.g., auditor, preferably would eventually approve the secondary stock option prior to the time of the initial offering.

In a preferred embodiment, the method would involve an auction structured in such a way that bidders (and ultimately the buyers) would be motivated to bid exactly what the bidders perceive to be the fair value of the asset involved in the secondary stock option. In this manner, the secondary stock option represents a proxy for market value of the employee stock option.

An alternate but also effective structure would involve a competitively executed auction. Such an auction, involving the sale and allocation of the secondary stock option to a number of bidders less than the total number of bidders would create a competitive mechanism resulting in a proxy for market value.

An important factor in creating the structure of the offering of the secondary stock options is to remove the ability of any party to influence or manipulate the outcome. The employer selling the secondary stock option and the parties attempting to acquire the secondary stock option should be subject to market, competitive or auction forces which determine the outcome of the transaction and, ultimately, the price paid for the secondary stock optoions.

The sale of the secondary stock options could be structured in numerous ways. FASB allows for negotiated transactions to be used for the purposes of capturing fair value. While it is expected that such negotiated transactions will take place and may be relied upon heavily in the future, early on such transactions are likely to be other than negotiated. The reason for this is that there is an unusual situation where both buyer and seller are motivated to execute the transaction at a low valuation. As such, auditors reviewing fair value might determine that the resulting valuation is not representative of fair value.

Once numerous competitive or auction transactions have been successfully executed, a number of fair value valuations for employee stock options will be available. These valuations may be used by auditors to establish a reasonable range within which similar securities may be valued. While the range itself may or may not be usefully applied to valuing similar securities, negotiated transactions executed within a reasonable range would be credible for the purpose of expense accounting.

In one example, the third party buyer(s) comprise accredited institutional investors. Such institutional investors are able to participate in private placements. Accredited institutions are sophisticated enough to understand the secondary stock option, able to assess the investment characteristics and risks involved and are liquid and have an long enough investment horizon to be able to purchase and hold such securities through their expiration.

The clearing price at which such transaction is executed would represent a quotable, fair market value as defined by FASB. During the course of evaluating the secondary stock option, institutional investors will evaluate and value the secondary stock option. Submitted bids will reflect perceived risk, uncertainty and other value inhibiting characteristics inherent to the secondary stock option. It is well established that the markets are far more efficient at quantifying the valuation characteristics of assets and handicapping expectations of their future performance. Based on the unusual characteristics intrinsic to the secondary stock option and the fact that these unusual characteristics are ignored by Black-Scholes, the clearing price of the competitively conducted auction is expected to be materially lower than that generated by Black-Scholes in most cases.

Based on specific FASB direction, the clearing price should be acceptable to auditors and the SEC as a quotable, fair value and is preferable for the purpose of accounting for employee issued options as expense.

Theoretically the secondary stock option could be executed at a valuation greater than that expected by Black-Scholes. This could occur for several reasons. The market might have a forward looking expectation for the volatility of the stock of the employer which exceeds that intrinsic to the historical stock prices of the company. One of the advantages of markets over formulas is that markets are forward looking and relying on a consensus expectation of the future.

A valuation greater than the Black-Scholes value might also result from inputs to Black-Scholes that have been manipulated below what reasonable investors might use. One of the problems with the formulaic option pricing methods is that they rely on inputs that are subjective. As such, they may be manipulated to minimize compensation expense. Either way the resulting valuation would be reflective of market value and efficient for the purpose of accounting for employee stock options.

Although possible, it is highly unlikely that a market valuation would result in excess of a Black-Scholes valuation. Firstly, investors can pay a Black-Scholes valuation for an exchange traded option. Such an option is owned, transferrable, not subject to forfeit, retains time value when sold, liquid, etc. Given the availability of unrestricted options at or near a Black-Scholes valuation, it is difficult to imagine the market valuing restricted options with employee stock option characteristics at similar levels. Further, even if the expected volatility is greater than historical levels, that disparity must overcome other value inhibiting characteristics such as length of capital commitment, non-transferability, forfeitability, etc., in order for the market valuation to exceed the Black-Scholes valuation. As such, it is expected that the market clearing price of a security that has value characteristics of employee stock options would be materially lower than that produced by existing stock option valuation methods.

Institutional investors have the opportunity and ability to evaluate the secondary stock option, assess risk, determine what level of return they would require for the level of risk they perceive and develop a valuation level at which they can place a bid. These investors determine what the secondary stock options are worth to them. As such, they can bid whatever price that they want.

As long as participants may bid whatever they want for the secondary stock option based on their assessment of the investment characteristics and determine whatever their return requirements are for enduring the risk, institutions will participate. Participation does not necessarily ensure allocation of securities, especially in a competitive transaction, but institutions will participate in a transaction whenever they believe that they can receive their required rate of return.

While the method involves the issuance of an incremental number of secondary stock options, dilution is not perceived to be a concern. The size of the proposed incremental transaction is perceived to be small in relative terms. For example, a firm issuing $100 million in Black-Scholes denominated employee stock options could issue a private placement of secondary stock options in the amount of $2 million. This would represent 2% incremental options being issued at first glance. But unlike those options granted to employees, the secondary stock options are sold to investors. As such, the transaction is a capital raising event at market valuations. Using the treasury method, or assuming that the employer could utilize capital raised to repurchase shares, would reduce this rate of dilution even further.

It is important to look at the dilution issue in the context of the entire transaction. The private placement is not being executed in a vacuum. It is expected that the transaction will result in a valuation event that will reduce the expense of the employee stock options relative to existing pricing methods. As such, dramatic cost savings are expected to be realized relative to the size of the private placement.

The net expected result is not dilution but a transaction which is dramatically accretive relative to a reliance on formulaic valuation methods.

The method results in a more accurate measure of valuation than existing option pricing models. Investors discount their valuations for all perceived value inhibiting characteristics which include but are not restricted to non-vested status, non-transferability of options, forfeitability and the uncertainty surrounding internally generated forfeiture estimates, extended time period over which capital is committed and other uncertainties and perceived risks.

The value proposition available to subscribers is compelling. The method restores options as viable and efficient compensation, incentive and retention tools. It is expected to produce materially lower compensation expense and increase reported earnings. The method provides better information to management which in turn allows greater flexibility and efficiency with which to structure compensation, incentive and retention packages for the employees. Employees will benefit from a clearer understanding of compensation. Finally, investors will have access to better information about the cost structure and earnings potential of the employer. The employer is expected to continue to execute existing and future employee compensation option plans as normal.

The specific number of secondary stock options issued may vary widely but will under normal circumstances be small in size relative to the Black-Scholes denominated employee issued amount. The size in dollar terms of the proposed transaction should in all cases be sufficiently large to allow for the establishment of a market price for the secondary stock options (as well as the employee stock options) in a competitively contested private placement offering.

The transaction's dollar value is defined by the ultimate transaction size rather than defined in terms of Black-Scholes denominated securities. The size of the transaction should be negotiated so as to ensure the successful execution of the proposed market-based transaction. As such, the offering preferably is large enough in size so as to attract a sufficient number of potential bidders and ensure that an efficient and competitive market method may be executed. The size of the transaction may be increased or decreased dependent upon market interest.

As indicated above, the restrictions of the secondary stock options will be identical or as closely resemble as is practicable those options being issued internally to employees. The employee granted and privately placed secondary stock options preferably will have identical strike prices and vesting periods. The secondary stock options also preferably are non-transferable, just like the employee options. The duration of the securities preferably is similar or identical to the duration assumption generated internally by the employer for the purposes of valuing the securities using Black-Scholes. The secondary stock options issued in the private placement preferably is forfeitable in the same proportion as the Company's employee issued options are eventually forfeited, as discussed above.

The employer preferably will provide, e.g., to a third party seller, all relevant data and assumptions used by the employer to internally value the employee issued options using Black-Scholes. This includes relevant data regarding internally granted option forfeitures and volatility calculations. Additionally, the employer preferably supplies, e.g., to a third party seller, all available data relating to historical forfeiture rates and the Company's estimate for future forfeitures related to the employee issuance in question. This information may be transmitted to potential bidders for the purpose of assisting them in determining a fair market value for the secondary stock options being offered in the private placement.

Before, concurrently with, or after the market close on the grant date, the executing party, e.g., the company or a third party seller, preferably conducts a private placement offering of the separate and incremental secondary stock options. It is contemplated that the private placement may be executed as, but not restricted to, a 506 offering. The offering could also be conducted as a 504, 505 offering or any other market based or negotiated financing event capable of capturing a competitive or negotiated market price for the securities.

The means by which the private placement is conducted and the method by which the securities are allocated is important to the valuation process. There are any number of variations to the capital market mechanism which would result in a successful transaction. One such example is included below.

The method by which the competitive private placement will be allocated to interested bidders preferably is an auction process whereby the securities are distributed only to accredited institutional investors. The proprietary auction process optionally is a modified form of a Dutch Auction. It should be designed for the express purpose of capturing a competitively generated and quotable fair market valuation. This process will produce a quotable fair market value, acceptable to auditors, FASB and the SEC for the purpose of accounting for employee issued options as a compensation expense.

Preferably, a third party seller, at the instruction of the employer, coordinates and executes the auction process to distribute the secondary stock options. The third party seller preferably contacts a sufficient number of accredited investors, preferably comprising institutional asset managers, to ensure adequate participation in the auction and to ensure a competitive bidding or auction process. The third party seller preferably communicates all available characteristics and restrictions of the secondary stock option being offering to prospective investors prior to the grant date. The third party seller will solicit indications of interest from interested parties based on the communicated terms of the transaction.

The strike price preferably is established and option parameters finalized on the grant date. The third party seller will communicate the final terms of the offering to potential investors, collect firm bids from investors and execute the auction mechanism. The clearing price of the auction process will establish a fair market valuation for the secondary stock options, which have the same characteristics and restrictions as the employee stock options offered internally by the employer to its employees.

The structure of the auction process preferably is designed to produce a fair market value derived from a competitive auction process. The auction mechanism may vary based on size of the transaction, specific characteristics of securities being sold, the employer issuing the securities, the market environment, the specific number of viable investors for which the specific securities under consideration are appropriate, or other unforeseen factors.

Generally, the auction process involves soliciting bids from a number of accredited institutional investors perceived to satisfy the threshold for a competitive market transaction. A maximum and minimum allowable purchase value per investor may be established. In this aspct, any bid received outside of this range will be considered a bid for the maximum or minimum allowable transaction value. Investors will be allowed to establish a minimum allocation at which they are willing to participate in the private placement. A valuation range within which bids will be accepted could be established. This valuation range could be based on the investment bank's expertise, independent estimates of the securities' value, input from the Company, past transaction data and any other available information relevant to the offering.

The offering is expected to be conducted under, but is not restricted to, the private offering exemption known as the Rule 506, Section D, exemption. The 506 offering is the preferable exemption due to its lack of size restrictions and limited restrictions.

Rule 506 of Regulation D restricts the employer from the use of general solicitation or advertising to market the securities. It allows the employer to sell its securities, e.g., secondary stock options, to an unlimited number of “accredited investors.” Securities do not need to be registered. Following the issuance the employer 11 would be required to file a “Form D”.

The clearing price at which the auction is executed will represent a fair market valuation, derived from a competitive auction process, conducted in an open manner, whereby any qualified institutional investor has the opportunity to participate and submit a bid. In all respects the auction will represent a quoted market price which the FASB believes to be “the best measure of the fair value of an asset, liability or equity instrument.” It is an open, visible and verifiable process.

The market issued methodology is superior to existing options pricing models in all respects. It relies on market forces, competitive bidding and qualified institutional investors to establish a market price. Inherent to the market price are implied discounts for the vesting period, non-transferability of the asset, forfeitability, uncertainties and other value diminishing characteristics. It does not rely on subjective assumptions applied to a formula, and it eliminates dependency of unrealistic and inappropriate restrictions and assumptions which are inherent to option pricing methods.

As indicated above, it is anticipated that the actual market value of the options as captured by the competitive auction process, will be materially lower than that calculated using Black-Scholes or other option pricing models. It is theoretically possible that the market value of issued options will be greater than that estimated by option pricing formulas. One such example of this occurring would be if the market's future expectation of volatility for the underlying security exceeded that captured by the historical share data used to capture the volatility input for option pricing models. Should such a situation transpire, insufficient bids would be received to execute the private placement within the established valuation range and the auction would not execute or become effective.

The employer may value its internally issued employee stock options using the same option pricing model and assumptions as it has typically relied upon. All conditions and restrictions of the options, including volatility or volatility methodology may be communicated to the third party buyer prior to grant date. The estimate of the employer of the expected life of the internally issued employee stock options would be used to set the duration of the options available for sale through the private placement auction process.

The internally granted employee options will have the same or similar duration to that of those issued via the private placement. FASB allows companies to value its employee options using behavioral assumptions about its employees relative to the options they are granted. While a group of granted options may have a ten year duration, the employer may value those options at, for instance, five years if it has reason to believe that its employees will on average exercise those options at year five. Since this assumption of a five year duration is the basis upon which the employer would value the options using Black-Scholes or other option pricing mechanisms, it is the appropriate duration to establish for the separately created and privately placed securities. Changing duration between the employee stock option and the secondary stock option is generally undesirable as it may create an incomparable security.

Employees generally lack the sophistication to value employee stock options, and generally do not fully comprehend the time value of options, lack sufficient liquidity to hold long duration options and have not purchased the options they control (typically, such options are granted by the employer to the employee). As such, they tend to display unusual and inefficient behavior with respect to their stock options. This is an argument FASB has advanced for allowing companies to value granted stock options at durations which are less than the face duration.

Accredited institutional investors who purchase options for cash are expected to display different behavior. Institutions typically pay cash for their options with a full understanding of the value they are receiving. They are valuing the time value of the securities and fully comprehend the persistence of such time value through expiration. They also generally understand that due to the (typical) non-transferability of the secondary stock options, early exercise will result in the loss of time value. Such institutions also are typically liquid enough to hold the purchased options through duration. They are familiar with the value maximization strategies associated with employee stock option attributes. As such, investors are expected to hold purchased options until expiration or close to expiration.

Due to behavioral differences, the duration calculated by the issuing company, which factors in the behavior of employees, is the appropriate duration for the secondary stock options that are sold to the investors.

Upon completion of the competitive market valuation process, the third party seller preferably provides the employer with the market clearing price and optionally a fairness opinion valuing the company's internally issued employee stock options, based on the competitive market process. If provided, the fairness opinion provides an overview of the valuation process and justification for its use as fair value.

The lack of comparable securities or transactions, a fundamental way in which many investors value and analyze securities, makes the initial or early investment in such a security a riskier proposition. Reasonable investors and institutions discount valuation in the face of risk. As transactions take place and investors have more data available to them, they will be more comfortable with the valuations they bid on such securities and the risk premium will fall.

These securities have never before been evaluated by investors. Academics have attempted to quantify the value of employee stock options but there is no consensus as to what employee stock options are actually worth. As such, institutional investors will have to invest material amounts of time into analyzing the complex securities. It is possible that bids may be lower initially to compensate investors through higher returns for the relative amount of time, efforts and resources that went into analyzing and valuing the securities in early transactions.

In any case, the price paid by the buyers (e.g., institutional investors) is reflective of market sentiment on the transaction date. A market value doesn't necessarily have to be a specific figure, just reflective of market sentiment. The market will process the transactions as they occur, and drive the price of future transactions up or down based on all the relevant inputs to the value proposition of the securities.

The method of the invention involves the creation of a new security, a new asset class and a new kind of transaction that solves the employee stock option valuation challenge. The method establishes a new kind of security distinct from both exchange traded options and employee stock options. The new securities are options that have been designed specifically to emulate the valuation characteristics of a distinct set of employee stock options. The parallel securities are equipped with characteristics that make them equal or sufficiently similar to the value of those securities granted to employees.

Those parallel securities are then sold in a specifically designed transaction. The design and execution of the method is created for the sole purpose of capturing the market value of the newly designed options. The successful execution of the transaction is effectively the goal. The valuation of the newly created options may then be applied to the original employee stock options for the purpose of accounting for those employee stock options as compensation expense.

In yet another embodiment, the invention is to an article, comprising a secondary security for sale to an independent buyer related to an employee stock option with a valuation paid by said independent buyer of said secondary security indicating a value of said employee stock option. In this embodiment, the secondary security preferably comprises a secondary stock option. As described above, the secondary security preferably has substantially all of the restrictions of the employee stock option. The valuation paid by said independent buyer of said secondary security preferably is a market value indicating said value of said employee stock option.

In yet another aspect, the invention is to an article for indicating a value of an employee stock option, comprising a secondary stock option security having substantially all of the restrictions of the employee stock option for sale to an independent buyer, optionally a multiplicity of independent buyers, with a valuation paid by said independent buyer indicating the value of said employee stock option. Preferably, the secondary stock option has substantially similar restrictions as imposed upon the employee stock option.

In this aspect, the employee stock option optionally comprises a vesting period during which an employee may not exercise said employee stock option. Additionally or alternatively, the employee stock option optionally has an exercise period during which an employee may exercise said employee stock option. Additionally or alternatively, the employee stock option optionally is forfeited upon termination of employment prior to the fulfillment of vesting requirements of the employee stock option. Additionally or alternatively, the employee stock option optionally is a non-transferable stock option. Additionally or alternatively, the employee stock option optionally has restrictions selected from the group consisting of: a strike price, a number of the shares underlying the option, a stock option vesting date; a stock option expiration date; and a stock option forfeiture term upon termination of employment prior to fulfillment of vesting requirement.

Similarly, the secondary stock option optionally has a vesting period during which said independent buyer may not exercise said secondary stock option. Additionally or alternatively, the secondary stock option optionally has an exercise period during which said independent buyer may exercise said secondary stock option. Additionally or alternatively, the secondary stock option optionally is non-transferable. Additionally or alternatively, the secondary stock option optionally has a forfeiture rate similar to a corresponding percentage of forfeitures within said employee stock option grant. Additionally or alternatively, the secondary stock option optionally has restrictions selected from the group consisting of: a strike price, a number of the shares underlying the option, a stock option vesting date; a stock option expiration date; and a secondary stock option forfeiture rate related to the employee stock options forfeited within the employee stock option grant.

As discussed above with reference to the method of the present invention, the secondary stock option preferably is sold in a transaction to one or more third party independent buyers. In one aspect, the value of the employee stock option is based on or includes the valuation paid by the independent buyer(s) to determine the value of the employee stock option. In another aspect, the value of the employee stock option includes the market valuation paid by the independent buyer to set the value of the employee stock option. In yet another aspect, the value of the employee stock option is based on or includes the valuation paid by the independent buyer as a basis to estimate the value of the employee stock option.

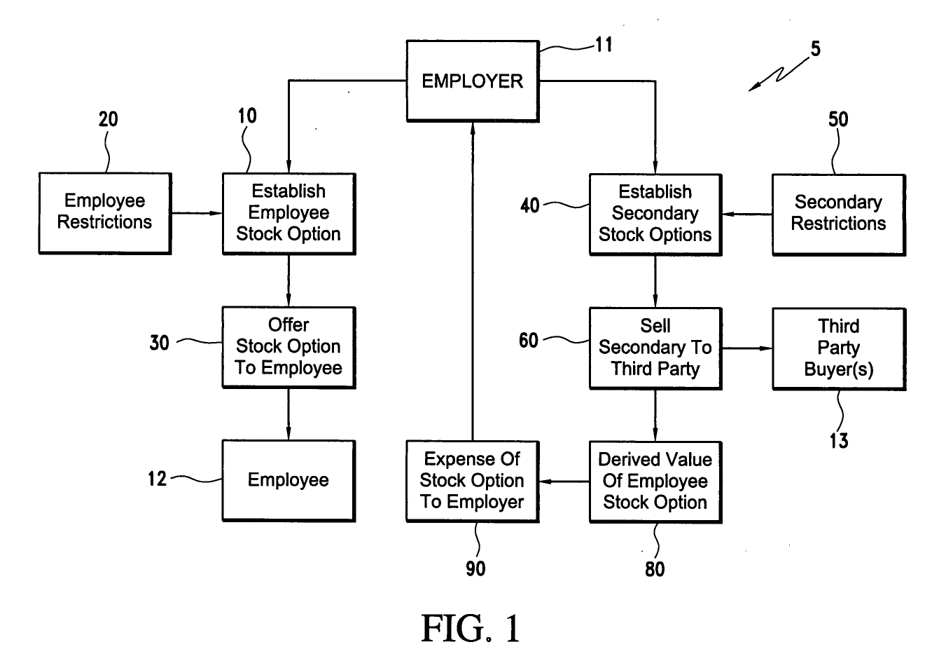

FIG. 1 provides a block diagram of the above-described embodiment of a method 5 for indicating the value of an employee stock option 10 issued by an employer 11 to an employee 12. The method 5 comprises the steps of establishing the employee stock option 10 having employee stock option restrictions 20. The employee stock option 10 includes a group of employee stock option restrictions 20. After establishing the employee stock option 10, the employer 11 offers 30 the employee stock option 10 to one or more employee(s) 12.

Additionally, the employer 11 establishes a secondary stock option 40 having secondary stock option restrictions 50. Preferably, the secondary stock option restrictions 50 comprise substantially the same restrictions as imposed upon the employee stock option restrictions 20.

The secondary stock options 40 are sold 60 to a single third party buyer or a plurality of third party buyers 13. Optionally, a third party seller (not shown) sells the secondary stock options 40 to the third party buyers 13 at the instruction of employer 11. Preferably, the secondary stock options 40 of the employer 11 are offered to a plurality of independent third party buyers 13. The price paid by the single or plurality of third party buyers 13 is used to provide a derived value 80 of the employee stock option 10.

The price paid by the independent third party buyer(s) 13 establishes a market value for the secondary stock options 40 by a single or a plurality of third party buyers 13. The market value established by the price paid by the single or the plurality of third party buyers 13 is then used to ascertain the value 80 of the employee stock option 10. Additionally, the price paid by the single or the plurality of third party buyers 13 is used to determine the expense 90 of the employee stock option 10 to be reported by the employer 11.

FIG. 2 is a diagram further illustrating the employee stock option restrictions 20. The employee stock option restrictions 20 may include one or more of the following restrictions. The employee stock option restrictions 20 may include a vesting period 21, an exercise period 22, a forfeiture upon termination condition 23, a non-transferable condition 24, a strike price 25, a number of shares 26 allocated to the employee stock option 10, a vesting date 27 and an expiration date 28. Thus, the employee stock option restrictions 20 may be selected from the group consisting of: a vesting period 21, an exercise period 22, a forfeiture upon termination condition 23, a non-transferable condition 24, a strike price 25, a number of shares allocated to the employee stock option 26, a vesting date 27, and an expiration date 28. A vesting period 21 is a period of time during which the employee 12 may not exercise the employee stock option 10. An exercise period 22 is a period of time during which the employee 12 may exercise the employee stock option 10. The forfeiture upon termination 23 is a condition in which the employee 12 loses all rights to the employee stock option upon termination of employee 12 with the employer 11 prior to the vesting period 21. The non-transferable 24 is a condition in which the employee 12 is restricted from selling, transferring or conveying in any manner any rights in the employee stock option 10. The strike price 25 is the price the employee 12 may purchase the shares of the employer 11 after the vesting period 21. The number of shares 26 is the allocated number of shares 26 offered to the specific employee 12 in the employee stock option 10.

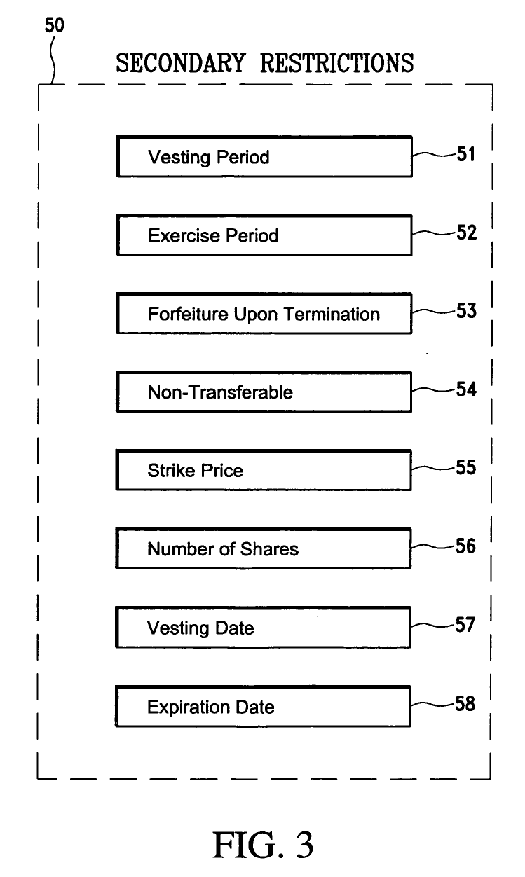

FIG. 3 is a diagram further illustrating the secondary stock option restrictions 50. The secondary stock option restrictions 50 preferably have substantially the same restrictions as the employee restrictions 30 of the employee stock option 10. Thus, the secondary stock option restrictions 50 may be selected from the group consisting of: a vesting period 51, an exercise period 52, a forfeiture upon termination condition 53, a strike price 55, and a number of shares allocated to the employee stock option 56, a vesting date 57 and an expiration date 58.

The forfeiture upon termination condition 53 of the secondary stock option 40 is related to the number of employee stock options 10 forfeited within the employee stock option 10. Preferably, the forfeiture upon termination condition 53 of the secondary stock option 40 is based on the percentage of the employees 12 who forfeit the employee stock option 10 by termination of the employee 12 prior to the end of the vesting period 21.

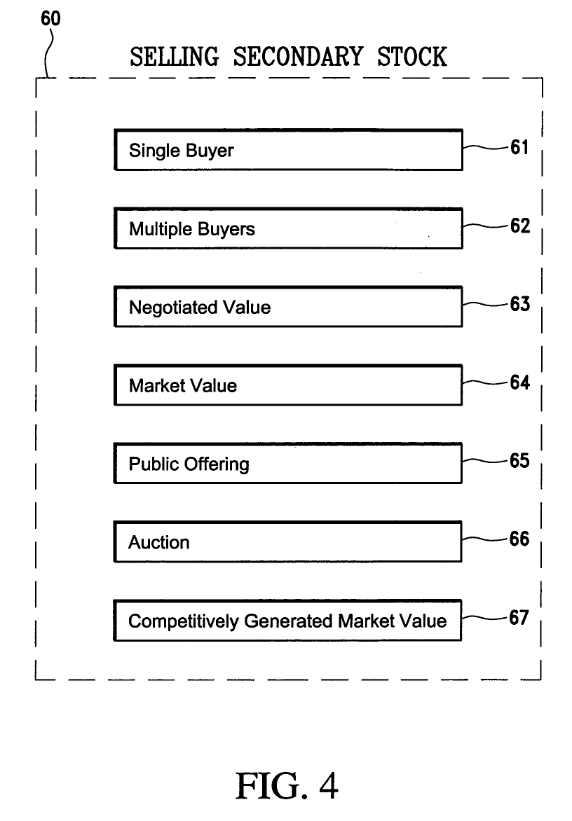

FIG. 4 is a diagram further illustrating the selling 60 of the secondary stock option 40 of FIG. 1. The selling 60 of the secondary stock option 40 may take various forms so long as the selling 60 of the secondary stock option 40 is related to a market value of the secondary stock option 40. The selling 60 of the secondary stock option 40 may be sold to a single buyer 61 or multiple buyers 62. The selling 60 of the secondary stock option 40 may be sold at a negotiated value 63 or a market value 64. Furthermore, the selling 60 of the secondary stock option 40 may be a public offering 65, an auction 66 such as a Dutch auction or any type of competitively generated market value 67.

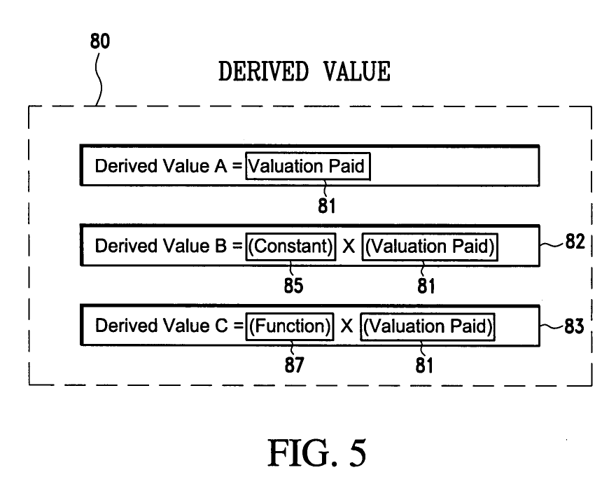

FIG. 5 is a diagram further illustrating how the derived value 80 of FIG. 1 may be determined. The derived value 80 may be obtained in several ways. In one embodiment, derived value (A) is based on the price or valuation paid 81 by the single or the plurality of third party buyers 13. The valuation paid 81 by the single or the plurality of third party buyers 13 for the secondary stock option 40 may be used to determine, to establish or to estimate the value of the employee stock option 10. Preferably, the derived value 80 is obtained directly using the valuation 81 paid by the single or the plurality of third party buyers 13. In this aspect, the valuation 81 paid by the single or the plurality of third party buyers 13 is the primary indication of the market value of the employee stock option 10. Optionally, the derived value 80 is obtained from an average or mean of the prices paid by a plurality of third party buyers 13.

In some instances, the derived value 80 may be expressed as an altered valuation 82 of the valuation 81 paid by the single or the plurality of third party buyers 13, as reflected by derived values B and C. In the altered valuation 82, derived value (B) is based on the valuation paid 81 multiplied by a constant 85. The constant 85 may be an integer, fraction and or decimal to alter the valuation paid 81 by the single or the plurality of third party buyers 13. The constant 85 may be determined empirically after the experience of one or more of the methods 5 of the present invention.

In other instances, the derived value 80 may be expressed as a modified valuation 83 of the valuation paid 81 by the single or the plurality of third party buyers 13. In the modified valuation 83, derived value C is based on valuation paid 81 multiplied by or incorporated into a mathematical function 87. The modified valuation 83 may be an exponent, a logarithm, and/or another mathematical functions, which modifies the valuation paid 81 by the single or the plurality of third party buyers 13. The mathematical function 87 may be determined empirically after the experience of one or more of the methods 5 of the present invention.

In another embodiment, the invention is to a method for indicating the value of an employee stock option issued by an employer to an employee, comprising the steps of: issuing the employee stock option having employee stock option; calculating a theoretical value of the employee stock option through the use of a mathematical model; obtaining a previous derived value from a previously issued secondary stock offering for a previously issued employee stock option; calculating a previous theoretical value for the previously issued employee stock option through the use of the mathematical model; calculating a correction factor from the previous derived value and the previous theoretical value for the previously issued employee stock option; and applying the correction factor to the theoretical value of the employee stock option to provide a calculated theoretical derived value to determine the expense of the employee stock option to the employer.

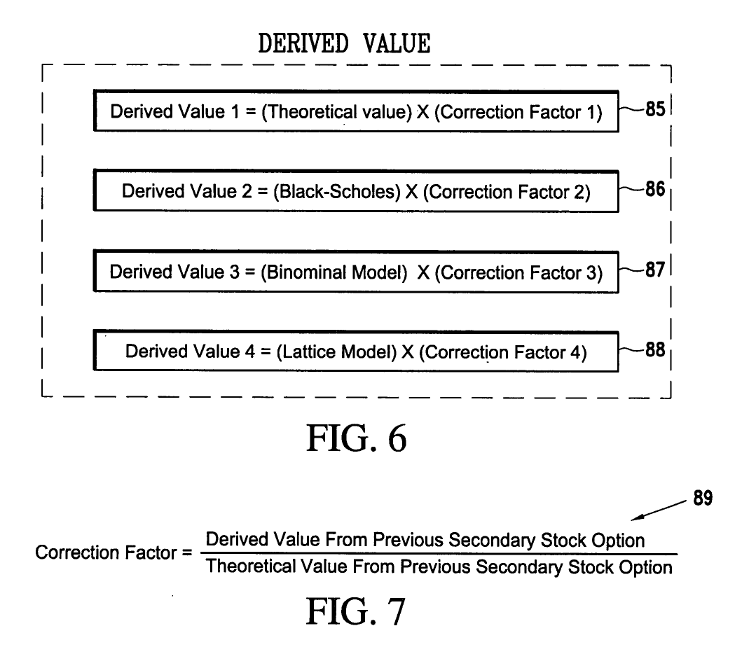

FIGS. 6-8 illustrate one non-limiting embodiment of this aspect of the invention. FIG. 6 is a diagram illustrating relationships of the derived value 80 of FIG. 1 with various theoretical mathematical models. In a first equation 85, a derived value (1) is equal to a theoretical value predicted by a generic mathematical model (not shown) multiplied by a correction factor (1). Since various mathematical models have been proposed by the prior art and are within the purview of those skilled in the art, the theoretical value is shown predicted by an unnamed mathematical model. In this embodiment, the correction factor (1) is preferably derived from previously determined implementations of the present invention. That is, the correction factor (1) may be determined from previously executed sales of secondary stock options 40 to third party buyer(s) 13.

In a second equation 86, a derived value (2) is equal to a Black-Scholes value predicted by the Black-Scholes mathematical model (not shown) multiplied by a correction factor (2). The Black-Scholes mathematical model is well known to those skilled in the art.

In a third equation 87, a derived value (3) is equal to a Binominal value predicted by the Binominal mathematical model (not shown) multiplied by a correction factor (3). The Binominal mathematical model is well known to those skilled in the art.

In a fourth equation 88, a derived value (4) is equal to a Lattice value predicted by the Lattice mathematical model (not shown) multiplied by a correction factor (4). The Lattice mathematical model is well known to those skilled in the art.

FIG. 7 is an equation 89 for determining a correction factor from a comparison of a derived value 80 with a theoretical value from a prior secondary stock option transaction 40. A previous secondary stock option transaction 40 provides a derived value 80 and an employer expense 90 in accordance with the method of FIG. 1. A correction factor may be determined through equation 89 by comparing the derived value 80 from a previous method of FIG. 1 and a theoretical value for the same transaction. For example, the correction factor may be determined if, on average, the discount produced by the valuation method of the present invention relative to that produced by a conventional model, e.g., Black-Scholes, was stable or in a narrow range. In this aspect, a company might attempt to avoid the market valuation mechanism altogether by implementing a valuation technique based on an equation 89 that implements information derived from previously executed market valuations.

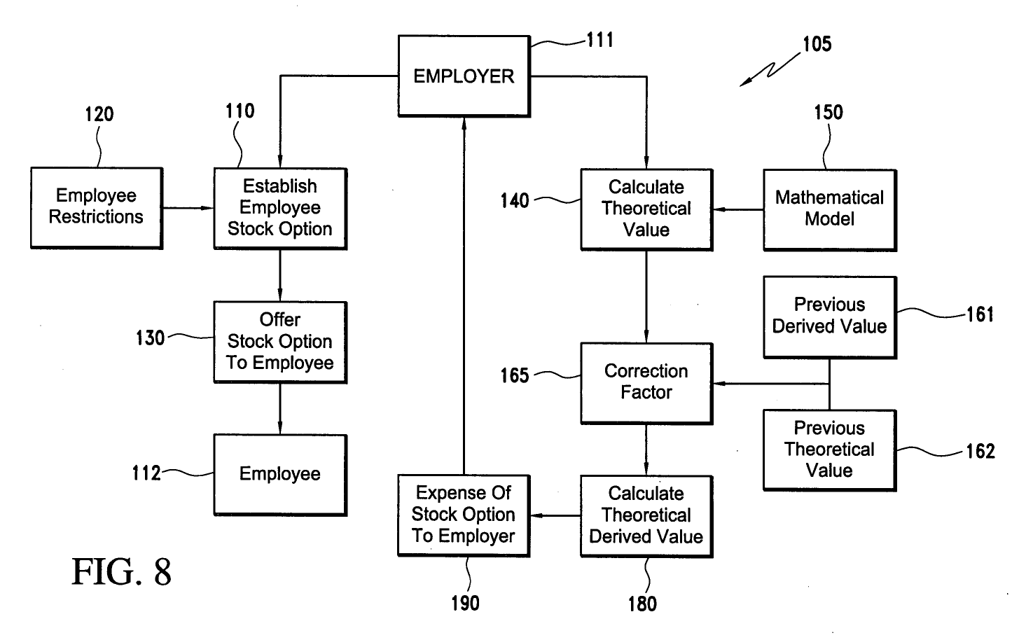

FIG. 8 is a block diagram of a second embodiment of a method 105 for indicating the value of an employee stock option 110 issued by an employer 111 to an employee 1112. The method 105 comprises the steps of establishing the employee stock option 110 having employee stock option restrictions 120. The employee stock option 110 includes a group of employee stock option restrictions 120 in a manner similar to the employee stock option restrictions 20 set forth in FIGS. 1 and 2. The employer 111 offers 130 the employee stock option 110 to the employee 112 in a manner similar to the method 5 of FIG. 1.

The employer 111 or agent thereof calculates a theoretical value 140 of the employee stock option 110. The theoretical value 140 is calculated through the use of a mathematical model 150. In the example, the mathematical model 150 may include a Black-Scholes mathematical model, a Binominal mathematical model, a Lattice mathematical model or any other suitable model.

A previous derived value 161 is obtained through a previously issued secondary stock offering for a previously issued similar employee stock option. For example, the previously issued employee stock option may be the employee stock option 10 shown in FIG. 1. Similarly, a previous theoretical value 162 is calculated for the previously issued employee stock option using the same mathematical model 150. For example, the previous theoretical value 162 may be calculated for the employee stock option 10 shown in FIG. 1 with mathematical model 150.

A correction factor 165 is calculated using the previous derived value 161 and the previous theoretical value 162 using the equation 89 shown in FIG. 7. The correction factor 165 is applied to the theoretical value 140 of the employee stock option 110 to calculate a theoretical derived value 180. The calculated theoretical derived value 180 is used to determine the expense 190 of the employee stock option 110 to be reported by the employer 111.

In one embodiment, the secondary stock option is presented to auditors of the employer for review and pre-approval of the employee stock option as well as the secondary stock option. Additionally or alternatively, the employee stock option and/or secondary stock option may be submitted to the Securities and Exchange Commission for confirmation of the method. The confirmation by the Securities and Exchange Commission may be issued in the form of inaction or a letter of no action.

After approval by the auditors of the employer and/or the Securities and Exchange Commission, a third party seller offers the secondary stock option to investors, e.g., institutional investors. The valuation or price paid by the to investors is used by the employer to provide a derived value indicative of the expense of the employee stock option to the employer.

As used herein, the term “Fair Value” means the amount at which an asset could be bought or sold in a current transaction between willing parties, that is, other than in a forced or liquidation sale. (FAS Concept Statement #7.) The FASB has indicated that the Fair Value of an equity share option or similar instrument shall be measured based on the observable market price of an option with the same or similar restrictions, if one is available.

The proposed transaction of the present invention relating to the sale of the secondary stock option should provide a Fair Value of the employee stock option. It is a current transaction, likely to be executed concurrent with the grant date. It is being executed between willing parties other than a forced liquidation. It involves the sale of a similar instrument that in fact was specifically designed to mimic the value characteristics of underlying employee stock options being valued. The transaction results in an observable market price.

A transaction, involving cash, for an asset is the best measure of that assets value. The price resulting from a market transaction takes into account the consensus view of the world, future expectations, risk tolerances, etc., in order to encapsulate the value of the security in a single price. No formula or set of assumptions generated by a employer or other single entity can capture the expectations of the market.

As long as such a transaction is properly executed, an auditor has no choice but to accept the clearing price as fair value, especially given the universally accepted shortcomings inherent to Black-Scholes and Binomial valuations.

While FASB allows for the use of a current negotiated transaction to be used as fair value, it is perceived that, at least initially, negotiated transactions will have a more challenging time being accepted by auditors as fair value. The problem initially is that both buyer and seller are motivated to execute the transaction at a low price. The lower the price the better off the purchaser is and the seller reaps cost savings from the valuation subsequently applied to the employee stock options.

The following FASB statements capture the benefit of a market-produced valuation relative to existing option pricing techniques.
“A transaction in the marketplace—an exchange for cash at or near to the date of the transaction—is the most common trigger for accounting recognition, and accountants typically accept actual exchange prices as fair value in measuring those transactions, absent persuasive evidence to the contrary. Indeed, the usual condition for using a measurement other than the exchange price is a conclusion that the stated price is not representative of fair value.”
“There is a long-standing preference in accounting for measurements based on observable marketplace amounts and transactions. The Board expects that accountants will continue to use observed amounts, when available, to determine the fair value of an asset or liability.”
   (FASB Statement of Financial Accounting Concepts No. 7.)

Effectively, the method 5 is not only acceptable to FASB and the SEC but is preferable relative to formulaic approaches. In the presence of a market produced valuation, auditors should use the transaction value over the flawed existing mechanisms.

### EXAMPLES

The present invention will be better understood in view of the following non-limiting prophetic examples.

### Example 1

Example 1 is a theoretical estimate of method 5 illustrated in FIG. 1. Employer decides to award an employee stock option grant. The employer establishes terms and conditions of the stock options being granted. The employer decides to issue 100 options to 100 employees with a strike price of $50, a 3 year vesting period, 10 year term to expiration, that are forfeitable and non-transferable. The employer awards the options to its employees. The employer, using Black-Scholes, values the individual employee stock options at $5 each and the entire option grant at $500.

The employer commits to selling secondary stock options. The employer decides to sell 10 secondary options with terms and restrictions that emulate the value proposition of the entire employee stock option grant. The secondary stock options have a strike price of $50, a 3 year vesting period, 10 year term to expiration, are forfeitable (in the same ratio as occurs within the employee stock option grant) and non-transferable. The secondary options are sold to third party buyers. The buyers place a market value on each individual option of $3 and purchase the entire transaction of 10 options for $30.

The market valuation of the secondary stock option which was designed with the same value features of the employee option grant represents a 40% discount to that calculated by Black-Scholes. The employer uses the market generated option valuation to value the employee stock option grant for the purpose of accounting for the employee stock option grant as compensation expense.

The net effect of using the market generated valuation to expense the stock option grant would be to reduce the compensation expense from $500, as calculated by Black-Scholes, to $300, the market valuation captured by the secondary option transaction.

### Example 2

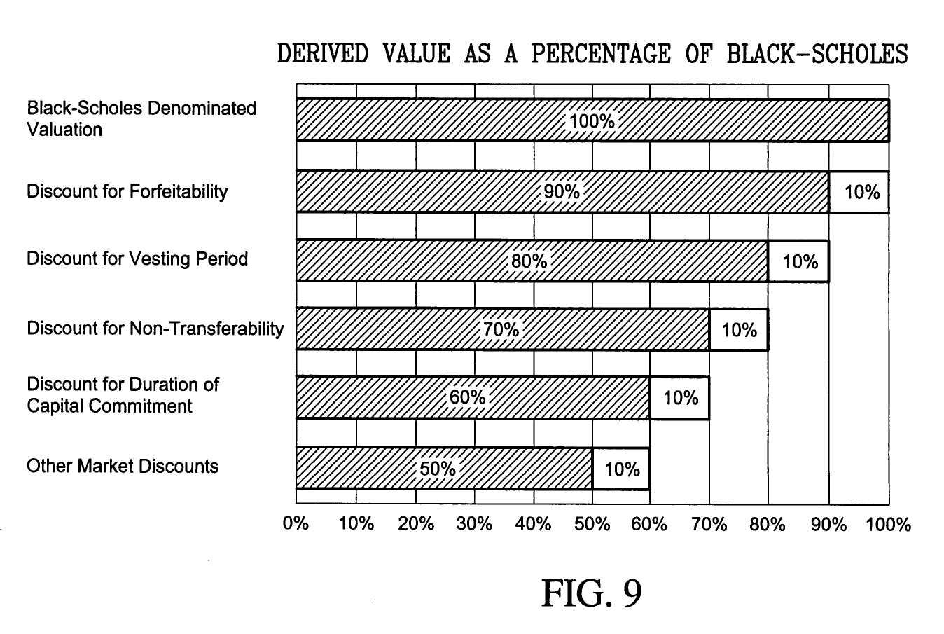

Example 2, which is provided by way of FIG. 9 of the drawings, is a theoretical estimate of the percent reduction of the Black Scholes value by the value derived by the method 5 of the present invention. Example 2 assumes a ten percent (10%) reduction of the Black Scholes value for the various restrictions of the secondary stock option 40 set forth in FIG. 3. This example illustrates that the actual market value for employee stock options is typically significantly less than the Black-Scholes denominated valuation.

### Example 3

Example 3 is a theoretical analysis comparing the Black Scholes value with value derived by the method 5 of the present invention. Example 3 assumes a 100 million dollar employee stock option 10 with method 5 yielding a value of forty percent (40%) of the value predicted by Black Scholes.

100 MILLION OF BLACK SCHOLES DENOMINATION V. TRANSACTION AT 40%

| Black-Scholes Method | | |
|---|---|---|
| Valuation | Private Placement Executed | 40% Savings Example |
| $100 Million of Black-Scholes | $1-$5 Million Private Placement | Clearing Prices Establishes |
| Denominated Employee Stock | Executed at 40% Discount to Black- | Employee Stock Option Valuation at |
| Options Granted | Scholes Valuation | 40% Discount to Black-Scholes |
| $100 Million of compensation | Subscribing Company Raises $1-$5 | $60 Million of Compensation |
| Expense Recorded | Million of Capital in Private Placement | Expense Recorded |
| $65 Million Reduction in | | $39 Million Reduction in Reported |
| Reported Earnings | | Earnings |
| | | $40 Million Expense Savings |
| | | $26 Million Increased Earnings |

### Example 4

Example 4 is a theoretical analysis of the financial impact of a theoretical case study. Example 4 compares the Black Scholes value with values derived by the method 5 of the present invention. This example compares values of ninety percent (90%), seventy percent (70%) and fifty percent (50%) of the value predicted by Black Scholes.

FINANCIAL IMPACT CASE STUDY

| | | | | | |
|---|---|---|---|---|---|
| B-S Denominated Valuation | 100% | Fair Market Valuation | 90% | 70% | 50% |
| B-S Denominated Grant | $100.0 | Clearing Price Valuation | $90.0 | $70.0 | $50.0 |
| Compensation Expense | $100.0 | Compensation Expense | $90.0 | $70.0 | $50.0 |
| Earnings Impact | $65.0 | Earnings Impact | $58.5 | $45.5 | $32.5 |
| Stock Price on Grant Date | $100.0 | Stock Price on Grant Date | $100.0 | $100.0 | $100.0 |
| Strike Price | $100.0 | Strike Price | $100.0 | $100.0 | $100.0 |
| Duration in Years | 5.0 | Duration in Years | 5.0 | 5.0 | 5.0 |
| B-S Value per Option | $1.0 | B-S Value per Option | $1.0 | $1.0 | $1.0 |
| Options Granted | 100 | Options Granted | 100 | 100 | 100 |
| Forfeiture Rate | 10.0% | Forfeiture Rate | 10.0% | 10.0% | 10.0% |
| Vesting Rate | 90.0% | Vesting Rate | 90.0% | 90.0% | 90.0% |
| Options Vesting | 90 | Options Vesting | 90 | 90 | 90 |
| Exercise at Year 5 | | Exercise at Year 5 | | | |
| Capital Received by Company | $9,000.0 | Capital Received by Company | $9,000.0 | $9,000.0 | $9,000.0 |
| Shares Issued | 90 | Shares Issued | 90 | 90 | 90 |
| Capital Received on Grant Date | $0.0 | Capital Received on Grant Date | $90.0 | $70.0 | $50.0 |

### Example 5

Example 5 is an analysis of the compensation expense and earning saving of a theoretical case study. Example 5 compares the Black Scholes value with values derived by the method 5 of the present invention. This example compares values of ten percent (10%), thirty percent (30%), fifty percent (50%), seventy percent (70%) and ninety percent (90%) of the value predicted by Black Scholes.

ANALYSIS OF COMPENSATION EXPENSE AND EARNING SAVINGS

| | | | | | |
|---|---|---|---|---|---|
| Black-Schools Denominated Stock Option Grant Valuation | 100.0% | | | | |
| Compensation Expense Recorded Using Black-Scholes | $100.0 | | | | |
| Assumed Tax Rate | 35.0% | | | | |
| Impact on Reported Earnings | $65.0 | | | | |
| Savings Relative to B-S Denominated Valuation | 10.0% | 30.0% | 50.0% | 70.0% | 90.0% |
| Clearing Valuation of Competitive Auction Relative to B-S | 90.0% | 70.0% | 50.0% | 30.0% | 10.0% |
| Compensation Expense | $90.0 | $70.0 | $50.0 | $30.0 | $10.0 |
| Assumed Tax Rate | 35.0% | 35.0% | 35.0% | 35.0% | 35.0% |
| Effect on Reported Earnings | $58.5 | $45.5 | $32.5 | $19.5 | $6.5 |
| Compensation Expense Savings Relative to B-S | $10.0 | $30.0 | $50.0 | $70.0 | $90.0 |
| Earnings Savings Relative to B-S Valuation | $6.5 | $19.5 | $32.5 | $45.5 | $58.5 |

One or more steps of the methods of the present invention can be performed by a computer program and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

The present disclosure includes that contained in the appended claims as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. The method for indicating the value of an employee stock option issued by an employer to an employee, comprising the steps of:
issuing the employee stock option having employee stock option restrictions;
establishing a secondary stock option of the stock of the employer having secondary stock option restrictions;
selling the secondary stock option to an independent buyer; and
deriving the value of the employee stock option from a valuation paid by the independent buyer for the secondary stock option.

2. The method for indicating the value of an employee stock option as set forth in claim 1, wherein the step of issuing the employee stock option includes the step of issuing the employee stock option having a vesting period during which the employee may not exercise the employee stock option.

3. The method for indicating the value of an employee stock option as set forth in claim 1, wherein the step of issuing the employee stock option includes the step of issuing the employee stock option having an exercise period during which the employee may exercise the employee stock option.

4. The method for indicating the value of an employee stock option as set forth in claim 1, wherein the step of issuing the employee stock option includes the step of issuing the employee stock option wherein the employee forfeits the stock option upon termination of employment prior to vesting.

5. The method for indicating the value of an employee stock option as set forth in claim 1, wherein the step of issuing the employee stock option includes the step of issuing a non-transferable stock option to the employee.

6. The method for indicating the value of an employee stock option as set forth in claim 1, wherein the step of issuing the employee stock option includes the step of issuing the employee stock option having restrictions selected from the group consisting of:
a strike price,
a number of the shares underlying the option,
a stock option vesting date;
a stock option expiration date; and
a stock option forfeiture term upon termination of employment prior to fulfillment of vesting requirement.

7. The method for indicating the value of an employee stock option as set forth in claim 1, wherein the step of establishing the secondary stock option includes the step of establishing an offering of the secondary stock options to a plurality of independent buyers.

8. The method for indicating the value of an employee stock option as set forth in claim 1, wherein the step of establishing the secondary stock option includes the step of establishing the secondary stock option having secondary stock option restrictions similar to the employee stock option restrictions.

9. The method for indicating the value of an employee stock option as set forth in claim 1, wherein the step of establishing the secondary stock option includes the step of establishing the secondary stock option having a vesting period during which the independent buyer may not exercise the secondary stock option.

10. The method for indicating the value of an employee stock option as set forth in claim 1, wherein the step of establishing the secondary stock option includes the step of establishing the secondary stock option having an exercise period during which the independent buyer may exercise the secondary stock option.

11. The method for indicating the value of an employee stock option as set forth in claim 1, wherein the step of establishing the secondary stock option includes the step of establishing the secondary stock option that is non-transferable by the independent buyer.

12. The method for indicating the value of an employee stock option as set forth in claim 1, wherein the step of establishing the secondary stock option includes the step of establishing the secondary stock options having a forfeiture rate related to the employee stock options forfeited within the employee stock option grant.

13. The method for indicating the value of an employee stock option as set forth in claim 1, wherein the step of establishing the secondary stock option includes the step of establishing the secondary stock option having restrictions selected from the group consisting of:
a strike price,
a number of the shares underlying the option,
a stock option vesting date;
a stock option expiration date; and
a secondary stock option forfeiture rate related to the employee stock options forfeited within the employee stock option grant.

14. The method for indicating the value of an employee stock option as set forth in claim 1, wherein the step of selling the secondary stock option to the independent buyer includes the step of selling the secondary stock option in a transaction at a market value.

15. The method for indicating the value of an employee stock option as set forth in claim 1, wherein the step of selling the secondary stock option to the independent buyer includes the step of selling the secondary stock option at a market value in an open market.

16. The method for indicating the value of an employee stock option as set forth in claim 1, wherein the step of selling the secondary stock option to the independent buyer includes the step of selling the secondary stock option to a multiplicity of independent buyers.

17. The method for indicating the value of an employee stock option as set forth in claim 1, wherein the step of selling the secondary stock option to the independent buyer includes the step of selling the secondary stock option at a competitively generated market value.

18. The method for indicating the value of an employee stock option as set forth in claim 1, wherein the step of deriving the value of the employee stock option includes the step of using the valuation paid by the independent buyer for the secondary stock option to determine the value of the employee stock option.

19. The method for indicating the value of an employee stock option as set forth in claim 1, wherein the step of deriving the value of the employee stock option includes the step of using the market valuation paid by the independent buyer for the secondary stock option to establish the value of the employee stock option.

20. The method for indicating the value of an employee stock option as set forth in claim 1, wherein the step of deriving the value of the employee stock option includes the step of using the valuation paid by the independent buyer for the secondary stock option as a basis to estimate the value of the employee stock option.

21. The method for indicating the market value of an employee stock option issued by an employer to a plurality of employees, comprising the steps of:
issuing an employee stock option to the plurality of employees having employee stock option restrictions imposed upon the plurality of employees in the exercise of the stock option;
establishing secondary stock options on the stock of the employer having secondary stock option restrictions being substantially the same as the employee stock option restrictions imposed upon the plurality of employees;
selling the secondary stock options to a multiplicity of independent buyers at market value; and
deriving the value of the employee stock options by using a valuation paid by the multiplicity of independent buyers of the secondary stock option.

22. The method for indicating the value of an employee stock option as set forth in claim 21, wherein the step of issuing the employee stock option includes the step of issuing the employee stock option having a vesting period during which the employee may not exercise the employee stock option.

23. The method for indicating the value of an employee stock option as set forth in claim 21, wherein the step of issuing the employee stock option includes the step of issuing the employee stock option having an exercise period during which the employee may exercise the employee stock option.

24. The method for indicating the value of an employee stock option as set forth in claim 21, wherein the step of issuing the employee stock option includes the step of issuing the employee stock option wherein the employee forfeits the stock option upon termination of employment prior to fulfillment of vesting requirement.

25. The method for indicating the value of an employee stock option as set forth in claim 21, wherein the step of issuing the employee stock option includes the step of issuing a non-transferable stock option to the employee.

26. The method for indicating the market value of an employee stock option as set forth in claim 21, wherein the step of issuing the employee stock option includes issuing an employee stock option having restrictions wherein an employee forfeits the employee stock option upon termination of the employee prior to vesting; and
the step of selling the secondary stock options includes selling the secondary stock options having a forfeiture rate equal to a corresponding percentage of employee stock option forfeitures in relation to the total number of employee stock options granted.

27. The method for indicating the value of an employee stock option as set forth in claim 21, wherein the step of establishing the secondary stock option includes the step of establishing an offering of the secondary stock options to the multiplicity of independent buyers.

28. The method for indicating the value of an employee stock option as set forth in claim 21, wherein the step of establishing the secondary stock option includes the step of establishing the secondary stock option having a vesting period during which the multiplicity of independent buyers may not exercise the secondary stock option.

29. The method for indicating the value of an employee stock option as set forth in claim 21, wherein the step of establishing the secondary stock option includes the step of establishing the secondary stock option having an exercise period during which the multiplicity of independent buyers may exercise the secondary stock option.

30. The method for indicating the value of an employee stock option as set forth in claim 21, wherein the step of establishing the secondary stock option includes the step of establishing the secondary stock option that is non-transferable by the multiplicity of independent buyers.

31. The method for indicating the value of an employee stock option as set forth in claim 21, wherein the step of establishing the secondary stock option includes the step of establishing the secondary stock options having a forfeiture rate equal to a corresponding percentage of the employee stock option forfeitures within the employee stock option grant.

32. The method for indicating the value of an employee stock option as set forth in claim 21, wherein the step of selling the secondary stock option to the multiplicity of independent buyers includes the step of selling the secondary stock option at market value.

33. The method for indicating the value of an employee stock option as set forth in claim 21, wherein the step of selling the secondary stock option to the multiplicity of independent buyers includes the step of selling the secondary stock option at a market value in a transaction.

34. The method for indicating the value of an employee stock option as set forth in claim 21, wherein the step of deriving the value of the employee stock option includes the step of using the valuation paid by the multiplicity of independent buyers for the secondary stock option to determine the value of the employee stock option.

35. The method for indicating the value of an employee stock option as set forth in claim 21, wherein the step of deriving the value of the employee stock option includes the step of using the market valuation paid by the multiplicity of independent buyers for the secondary stock option to set the value of the employee stock option.

36. The method for indicating the value of an employee stock option as set forth in claim 21, wherein the step of deriving the value of the employee stock option includes the step of using the valuation paid by the multiplicity of independent buyers for the secondary stock option as a basis to estimate the value of the employee stock option.

37. The method for indicating the value of an employee stock option issued by an employer to an employee, comprising the steps of:
issuing the employee stock option having employee stock option;
calculating a theoretical value of the employee stock option through the use of a mathematical model;
obtaining a previous derived value from a previously issued secondary stock offering for a previously issued employee stock option;
calculating a previous theoretical value for the previously issued employee stock option through the use of the mathematical model;
calculating a correction factor from the previous derived value and the previous theoretical value for the previously issued employee stock option; and
applying the correction factor to the theoretical value of the employee stock option to provide a calculated theoretical derived value to determine the expense of the employee stock option to the employer.

38. An article, comprising:
a secondary security for sale to an independent buyer related to an employee stock option with a valuation paid by said independent buyer of said secondary security indicating a value of said employee stock option.

39. An article as set forth in claim 38, wherein said secondary security is a secondary stock option.

40. An article as set forth in claim 38, wherein said secondary security has substantially all of the restrictions of the employee stock option.

41. An article as set forth in claim 38 wherein said valuation paid by said independent buyer of said secondary security is a market value indicating said value of said employee stock option.

42. An article for indicating a value of an employee stock option, comprising:
a secondary stock option security having substantially all of the restrictions of the employee stock option for sale to an independent buyer with a valuation paid by said independent buyer indicating the value of said employee stock option.

43. An article for indicating the value of an employee stock option as set forth in claim 42, wherein said employee stock option has a vesting period during which an employee may not exercise said employee stock option.

44. An article for indicating the value of an employee stock option as set forth in claim 42, wherein said employee stock option has an exercise period during which an employee may exercise said employee stock option.

45. An article for indicating the value of an employee stock option as set forth in claim 42, wherein said employee stock option is forfeited upon termination of employment prior to the fulfillment of vesting requirements of the employee stock option.

46. An article for indicating the value of an employee stock option as set forth in claim 42, wherein said employee stock option is a non-transferable stock option.

47. An article for indicating the value of an employee stock option as set forth in claim 42, wherein said employee stock option has restrictions selected from the group consisting of:
a strike price,
a number of the shares underlying the option,
a stock option vesting date;
a stock option expiration date; and
a stock option forfeiture term upon termination of employment prior to fulfillment of vesting requirement.

48. An article for indicating the value of an employee stock option as set forth in claim 42, wherein said secondary stock option has substantially similar restrictions as imposed upon the employee stock option.

49. An article for indicating the value of an employee stock option as set forth in claim 42, wherein said secondary stock option has a vesting period during which said independent buyer may not exercise said secondary stock option.

50. An article for indicating the value of an employee stock option as set forth in claim 42, wherein said secondary stock option has an exercise period during which said independent buyer may exercise said secondary stock option.

51. An article for indicating the value of an employee stock option as set forth in claim 42, wherein said secondary stock option is non-transferable.

52. An article for indicating the value of an employee stock option as set forth in claim 42, wherein said secondary stock options has a forfeiture rate similar to a corresponding percentage of forfeitures within said employee stock option grant.

53. An article for indicating the value of an employer stock option as set forth in claim 42, wherein said secondary stock option has restrictions selected from the group consisting of:
a strike price,
a number of the shares underlying the option,
a stock option vesting date;
a stock option expiration date; and
a secondary stock option forfeiture rate related to the employee stock options forfeited within the employee stock option grant

54. An article for indicating the value of an employer stock option as set forth in claim 42, wherein said secondary stock option is sold in a transaction.

55. An article for indicating the value of an employee stock option as set forth in claim 42, wherein said independent buyer includes a multiplicity of independent buyers.

56. An article for indicating the value of an employee stock option as set forth in claim 42, wherein the value of said employee stock option includes said valuation paid by said independent buyer to determine the value of said employee stock option.

57. An article for indicating the value of an employee stock option as set forth in claim 42, wherein the value of said employee stock option includes the market valuation paid by said independent buyer to set the value of said employee stock option.

58. An article for indicating the value of an employee stock option as set forth in claim 42, wherein the value of said employee stock option includes said valuation paid by said independent buyer as a basis to estimate the value of said employee stock option.
